(19) United States
(12) Patent Application Publication
(10) Pub. No.: US 2026/0301243 A1
(43) Pub. Date: Oct. 1, 2026

(54) RECORDING MEDIUM, DESIGN PROJECT MANAGEMENT APPARATUS, DESIGN PROJECT MANAGEMENT SYSTEM, AND DESIGN PROJECT MANAGEMENT METHOD

(71) Applicant: Konica Minolta, Inc., Tokyo (JP)

(72) Inventor: Taro TAKECHI, Tokyo (JP)

(21) Appl. No.: 19/578,517

(22) Filed: Mar. 25, 2026

(30) Foreign Application Priority Data
Mar. 31, 2025 (JP) 2025-057786

(51) Int. Cl. G06T 11/00; G06F 40/268; G10L 15/26

(52) U.S. Cl. CPC G06T 11/00; G06F 40/268; G10L 15/26

(57) ABSTRACT

A non-transitory computer-readable recording medium storing a program that causes a hardware processor included in a computer of a design project management apparatus to perform, acquiring audio data, recognizing the audio data and converting the audio data into text data, extracting a requirement from the text data, causing an image generation AI to generate a generated image based on a design requirement included in the requirement, and displaying the generated image on a display.

### CROSS-REFERENCE TO RELATED APPLICATION

The entire disclosure of Japanese Patent Application No. 2025-057786, filed on Mar. 31, 2025, including the description, claims, drawings, and abstract, is incorporated herein by reference.

### BACKGROUND OF THE INVENTION

### Technical Field

The present disclosure relates to a recording medium, a design project management apparatus, a design project management system, and a design project management method.

### Description of Related Art

Conventionally, a client requesting creation of a design may not have a specific idea, and even when production is performed based on contents of business negotiations, rework may occur due to differences in understanding, which can increase man-hours and costs.

Accordingly, for example, Japanese Unexamined Patent Application Publication No. 2021-120709 discloses an information processing system that performs speech recognition on audio data of a business negotiation to convert the audio data into text and then analyzes the text. With such information processing system, sharing text-converted business negotiation content with a client can suppress occurrence of rework caused by the difference in the understanding with the client.

### SUMMARY OF THE INVENTION

However, such information processing system is not specialized for design creation and merely outputs text data. Therefore, even if the understanding is shared with the client based on the text, the difference may exist in the understanding related to the text, and the rework may still occur.

The present disclosure has been made in view of such circumstances. An object of the present disclosure is to provide a recording medium, a design project management apparatus, a design project management system, and a design project management method that can reduce man-hours and costs in design creation.

In order to solve the above-described problem, according to one aspect of the present disclosure a non-transitory computer-readable recording medium storing a program that causes a hardware processor included in a computer of a design project management apparatus to perform,
acquiring audio data,
recognizing the audio data and converting the audio data into text data,
extracting a requirement from the text data,
causing an image generation AI to generate a generated image based on a design requirement included in the requirement, and
displaying the generated image on a display.

According to another aspect of the present disclosure, a design project management apparatus reflecting one aspect of the present disclosure includes:
a hardware processor,
wherein the hardware processor is configured to perform,
acquiring audio data,
recognizing the audio data and converting the audio data into text data,
extracting a requirement from the text data,
causing an image generation AI to generate a generated image based on a design requirement included in the requirement, and
displaying the generated image on a display.

According to another aspect of the present disclosure, a design project management system reflecting one aspect of the present disclosure includes:
the design project management apparatus described above;
an image generating server configured to cause the image generation AI to generate the generated image; and
a user terminal including a sound collector configured to convert audio into the audio data, and the display configured to display the generated image.

According to another aspect, a design project management method performed by a computer of a design project management apparatus, the method reflecting one aspect of the present disclosure includes:
acquiring audio data,
recognizing the audio data and converting the audio data into text data,
extracting a requirement from the text data,
causing an image generation AI to generate a generated image based on a design requirement included in the requirement, and
displaying the generated image on a display.

### BRIEF DESCRIPTION OF THE DRAWINGS

The advantages and features provided by one or more embodiments of the invention will become more fully understood from the following detailed description and the accompanying drawings, which are given by way of illustration only, and thus are not intended as a definition of the limits of the present disclosure, and wherein:

FIG. 1 is a block diagram of a design project management system;

FIG. 2 is a flowchart of a design project management process;

FIG. 3 is an example of an image generation screen;

FIG. 4 is an example of the image generation screen;

FIG. 5 is an example of a generation condition setting screen;

FIG. 6 is an example of the generation condition setting screen;

FIG. 7 is an example of the generation condition setting screen;

FIG. 8 is an example of an image generation screen;

FIG. 9 is an example of the image generation screen; and

FIG. 10 is an example of a report.

### DETAILED DESCRIPTION

Hereinafter, one or more embodiments of the present disclosure will be described with reference to the drawings. However, the scope of the invention is not limited to the disclosed embodiments.

Hereinafter, embodiments of the present disclosure will be described with reference to the drawings. However, the scope of the present disclosure is not limited to the embodiments described below or the drawings.

### Design Project Management System

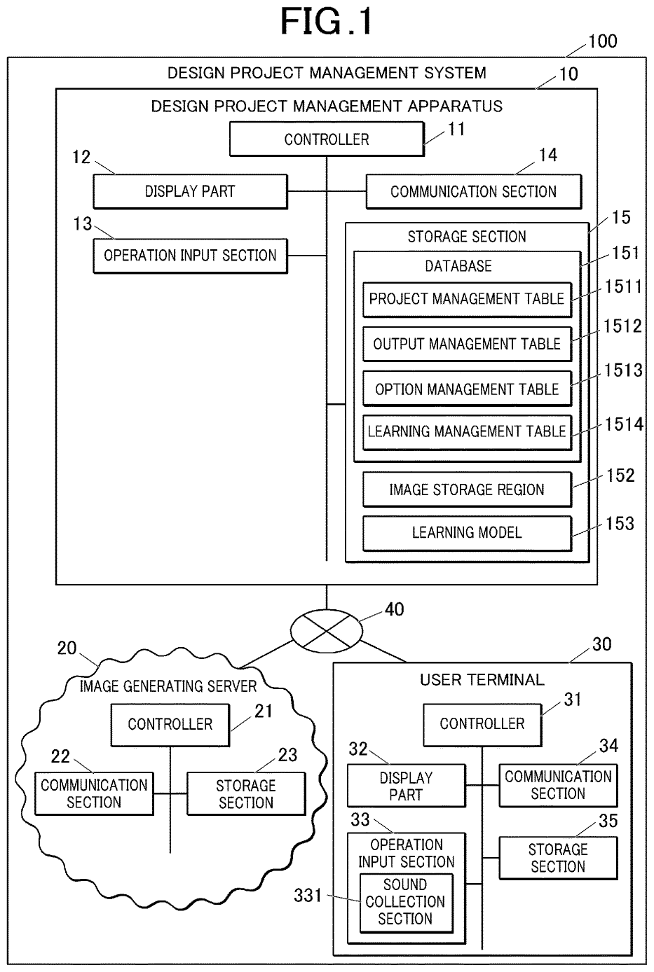

FIG. 1 is a block diagram illustrating a functional configuration of a design project management system (hereinafter referred to as the “system”) 100. As illustrated in FIG. 1, the system 100 includes a design project management apparatus (hereinafter, “apparatus”) 10, an image generating server (hereinafter, “server”) 20, and a user terminal (hereinafter, “terminal”) 30. The apparatus 10, the server 20, and the terminal 30 transmit and receive information via a communication network 40. The communication network 40 may be a local area network (LAN), a wide area network (WAN), the Internet, or the like.

### Design Project Management Apparatus

The apparatus 10 executes various processes related to design project management based on operation instructions acquired from the terminal 30. The apparatus 10 includes a controller 11 (hardware processor), a display part (display) 12, an operation input section 13, a communication section 14, and a storage section 15.

### Controller

The controller 11 includes a central processing unit (CPU), random access memory (RAM), read-only memory (ROM), and the like. The CPU of the controller 11 reads various programs stored in the storage section 15, loads the programs into the RAM, executes various processes in accordance with the loaded programs, and controls operations of the respective units of the apparatus 10.

### Acquisition Section

In particular, the controller 11 functions as an acquisition section configured to acquire, from the terminal 30, audio data of a business negotiation with a client regarding generating a generated image and operation data of a user. In particular, the acquisition section receives a client setting instruction regarding generating the generated image and a setting instruction of a generation condition for the generated image.

### Conversion Section

Further, the controller 11 functions as a conversion section that converts the acquired audio data and operation data into text data. The controller 11 serving as the conversion section converts the audio data into the text data using, for example, a dictionary database or the like stored in the storage section 15. In addition, the controller 11 serving as the conversion section converts, into the text data, the operation data of the user input via an operation input section 33 (described later) on an image generation screen 51 (described later), using known log recording software, a JavaScript (registered trademark) library, or the like.

### Extraction Section

Further, the controller 11 functions as an extraction section configured to extract requirements from the text data. Upon acquiring the text data from the conversion section, the controller 11 serving as the extraction section extracts various requirements by using natural language processing programs, such as a syntactic analysis program and a morphological analysis program, and/or a Large Language Model (LLM).

The requirements extracted by the extraction section are broadly classified into two types, design requirements and meeting requirements. The design requirement includes a request overview, an objective, a goal, an appeal point, competitor information, an applicable medium, a target product, a target, a concept, a taste, a number of pages, a number of copies, the presence or absence of bleed, processing details, a desired paper type, and the like. The meeting requirements include a delivery deadline, a delivery destination, a schedule, and the like.

### Image Generation Controller, Art Style Generation Section

The controller 11 functions as an image generation controller that causes the server 20 to generate the generated image in accordance with the generation condition, based on the operation instruction by the user. Further, the controller 11 functions as an art style generation section that, based on contents stored in the storage section 15, causes a learning model 153, described below, to generate art style data corresponding to the client.

### Learning Section

The controller 11 also functions as a learning section configured to, based on content stored in an output management table 1512 described below, learn, for each client, a tendency in selecting the generation condition set when generating the generated image. For example, the learning section refers to, among records in the output management table 1512, a record including a predetermined client, and stores, in the storage section 15 in association with the predetermined client, the generation condition that has been selected a predetermined number of times and/or a predetermined ratio or more.

### Display Controller

In addition, the controller 11 functions as a display controller that causes a display part 32 (described later) of the terminal 30 to display various screens for executing design project management processing, including generating the generated image. In this instance, the display controller controls display content of the display part 32 such that the generation condition for generating the generated image differ for each client.

### Report Generation Section, Transmitting Section

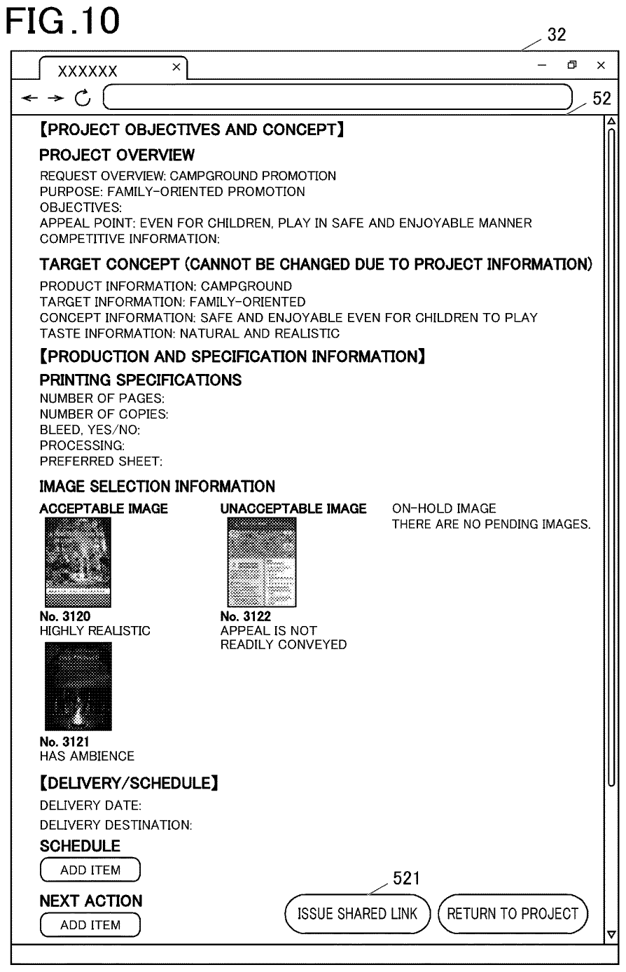

The controller 11 functions as a report generation section that generates a report 52 (see FIG. 10) based on requirements extracted by the extraction section. The controller 11 functions as a transmitting section that transmits the generated report 52 or information related to the report 52 to the client. The design project management processing and the report 52 will be described later.

### Display Part

The display part 12 includes a monitor such as a liquid crystal display (LCD), and is configured to display various screens and the like in accordance with an instruction of a display signal input from the controller 11.

### Operation Input Section

The operation input section 13 is a keyboard including cursor keys, numeric input keys, various function keys, and the like, a pointing device such as a mouse, a touch screen overlaid on a surface of the display part 12, or the like. The operation input section 13 is configured to be operable by an operator. The operation input section 13 outputs, to the controller 11, various signals based on operations performed by the operator.

### Communication Section

The communication section 14 is configured to be able to transmit and receive various signals and various data to and from other devices and the like connected via the communication network 40.

### Storage Section

The storage section 15 includes a nonvolatile semiconductor memory, a hard disk, and the like, and stores various programs to be executed by the controller 11, parameters necessary for executing the programs, various data, and the like. The storage section 15 includes a database 151, an image storage area 152, and a learning model 153.

### Database

The database 151 stores, in a searchable manner, various types of information related to the design project management processing. The database 151 includes, for example, a project management table 1511, an output management table 1512, an option management table 1513, and a learning management table 1514.

The project management table 1511 stores data related to each business negotiation. In the project management table 1511, a client name of the client with which the business negotiation was conducted, a path to the generated image generated in the course of the business negotiation, a concept, a date and time at which the business negotiation was conducted, a last update date and time, text data generated in the business negotiation, and the like are stored in association with one another. As will be described later, the text data generated in the business negotiation includes operation data related to feedback on the generated image.

The output management table 1512 stores the generation condition for each generated image. In the output management table 1512, the name of the client for which the generated image is generated, the path to the generated image that is generated, setting contents of the respective generation conditions, and the like are stored in association with one another.

In the option management table 1513, the client name and a display setting for a generation option, which will be described later, are stored in association with each other. In the learning management table 1514, the client name, the keyword (art style name), training image path, and art style data are stored in association with each other. The contents stored in the option management table 1513 and the learning management table 1514 can be added, modified, and deleted at any time through a user operation.

### Image Storage Area

The image storage area 152 stores the generated image that the image generation controller causes the server 20 to generate, the training image received from the terminal 30, and the like.

### Learning Model

The learning model 153 is provided for each client. The learning model 153 generates art style data for the client by using, as training data, the generated image for each client stored in the image storage area 152 and the operation data, stored in the project management table 1511, relating to the feedback on the generated image. The learning model 153 may be, for example, a regression model such as polynomial regression, multiple regression, support vector regression, or random forest regression. The learning model 153 may alternatively be another model such as a neural network. Further, in response to an instruction from the art style generation section, the learning model 153 may be additionally trained using the generated image generated after the art style data is generated and/or the training image stored in the image storage area 152.

In addition, the storage section 15 stores a Web server program, an application program, and the like. The Web server program communicates, using an HTTP protocol or the like, with a Web browser or a program installed in the terminal 30, and provides a Web site for using the design project management system 100, thereby implementing the functions of a Web server. The application program runs on the Web server to perform various kinds of processing. In addition, the storage section 15 stores the natural language processing program and the LLM used by the conversion section.

### Image Generating Server

The server 20 includes functionality as an image generation AI, and generates the generated image. The server 20 includes a controller 21, a communication section 22, and a storage section 23.

### Controller

The controller 21 includes a CPU, a RAM, a ROM, and the like. The CPU of the controller 21 reads various programs stored in the storage section 23, loads the programs into the RAM, executes various processes in accordance with the loaded programs, and controls operations of the respective units of the server 20.

The controller 21 uses a text generation AI to generate a prompt based on data acquired from the apparatus 10. In addition, the controller 21 generates the generated image from the prompt using an image generation AI. Details of processing for generating the generated image will be described later.

Examples of the text generation AI include ChatGPT, Bard, Gemini, and Bloom. Examples of the image generation AI include Stable Diffusion, DALL·E2, Midjourney, starryai, and Dream by WOMBO. However, the image generation AI and the text generation AI are not limited to those described above.

### Communication Section

The communication section 22 is configured to transmit and receive various signals and various data to and from other devices, etc., connected via the communication network 40.

### Storage Section

The storage section 23 comprises a nonvolatile semiconductor memory, a hard disk, or the like. The storage section 23 stores various programs to be executed by the controller 21, parameters necessary for executing the programs, various data, and the like.

### User Terminal

The terminal 30 is used to input and output various data in the design project management system 100. Since it is preferable that the user brings the terminal 30 to the business negotiation with the client and promptly displays the generated image based on the content (audio data) of the business negotiation, the terminal 30 is preferably a portable terminal, such as a smartphone, a tablet, or a notebook PC. However, when the user and the client conduct business negotiations in a non-face-to-face manner, the terminal 30 may be a stationary terminal, such as a desktop PC. The terminal 30 includes a controller 31, the display part (display) 32, the operation input section 33, a communication section 34, and a storage section 35.

### Controller

The controller 31 includes a CPU, RAM, ROM, and the like. The CPU of the controller 31 reads various programs stored in the storage section 35, loads the programs into the RAM, executes various processing in accordance with the loaded programs, and controls operations of the respective units of the terminal 30.

### Display Part

The display part 32 includes a monitor such as the LCD, and is configured to display various screens and the like in accordance with the instruction of the display signal input from the controller 31.

### Operation Input Section

The operation input section 33 is a keyboard including cursor keys, numeric input keys, various function keys, and the like, a pointing device such as a mouse, a touch screen overlaid on a surface of the display part 32, or the like. In particular, the operation input section 33 includes a sound collection section 331 (sound collector) such as a microphone configured to acquire audio data in the business negotiation between the user and the client. The operation input section 33 is configured to be operable by the operator. Further, the operation input section 33 outputs, to the controller 31, various signals based on operations performed by the operator.

The communication section 34 is configured to be able to transmit and receive various signals and various data to and from other devices and the like connected via the communication network 40.

The storage section 35 includes a nonvolatile semiconductor memory, a hard disk drive, or the like. The storage section 35 stores various programs to be executed by the controller 31, parameters required to execute the programs, various data, and the like.

### Design Project Management Processing

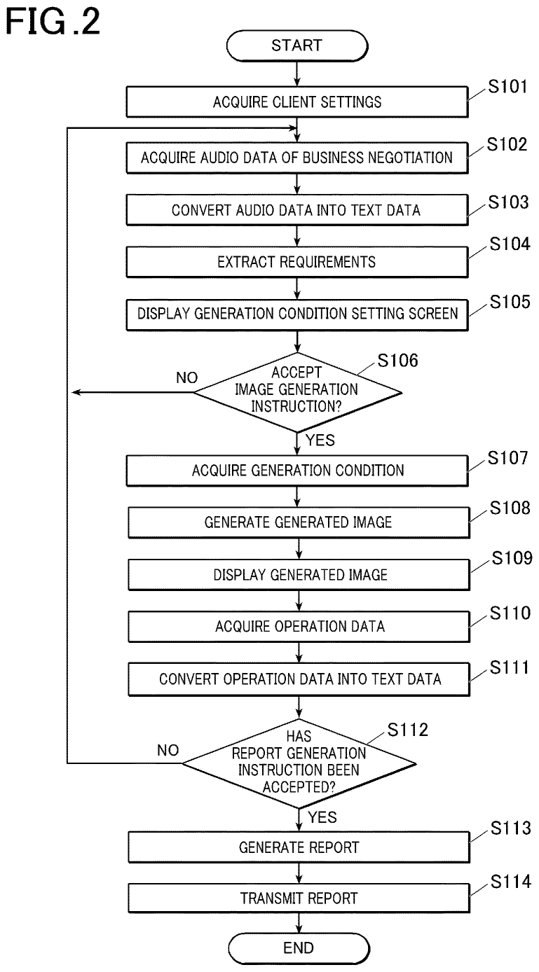

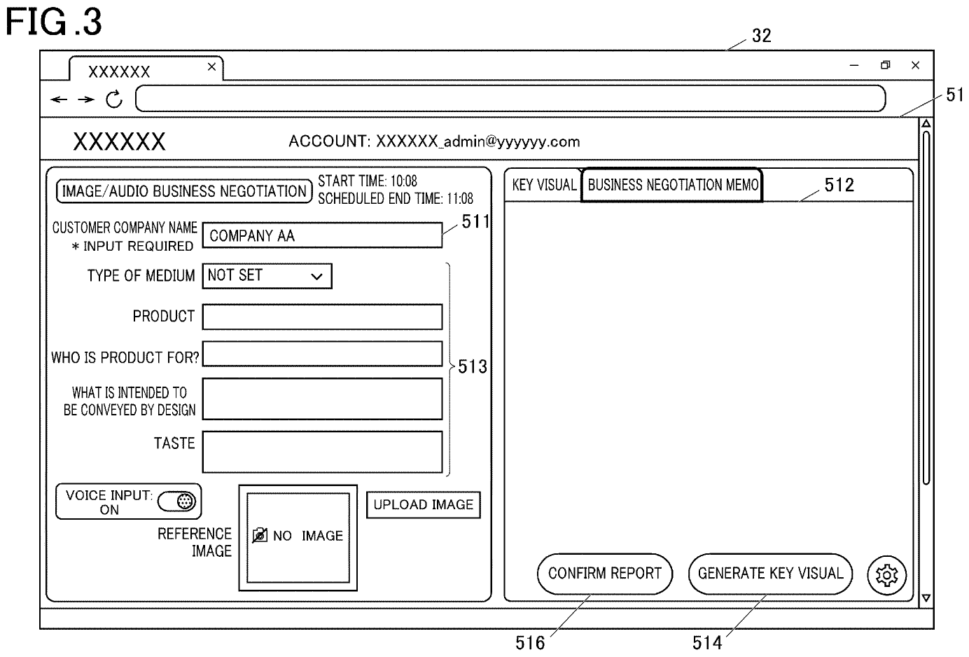

The design project management processing in the design project management system 100 will be described with reference to the flowchart of FIG. 2 and to the screen examples and screen transitions shown in FIG. 3 to FIG. 10. First, when the user of the terminal 30 inputs, into the web browser, a specified URL represented by IP information and/or the like of the apparatus 10, the display controller causes the display part 32 to display a predetermined login screen and performs login authentication. Upon successful login authentication, the display controller displays a project list screen based on the stored contents of the project management table 1511, and accepts selection of a project or creation of a new project.

When the creation of the new project is accepted, the display controller of the apparatus 10 displays, on the display part 32 of the terminal 30, the image generation screen 51 as shown in FIG. 3. The user enters a client name (“Company AA”) into a client input field 511. The acquisition section of the apparatus 10 acquires the client setting (step S101).

Further, the user issues the instruction to start recording and starts the business negotiation with the client. The controller 31 of the terminal 30 converts the audio of the business negotiation collected by the sound collection section 331 into the audio data. Then, the communication section 34 transmits the audio data to the apparatus 10.

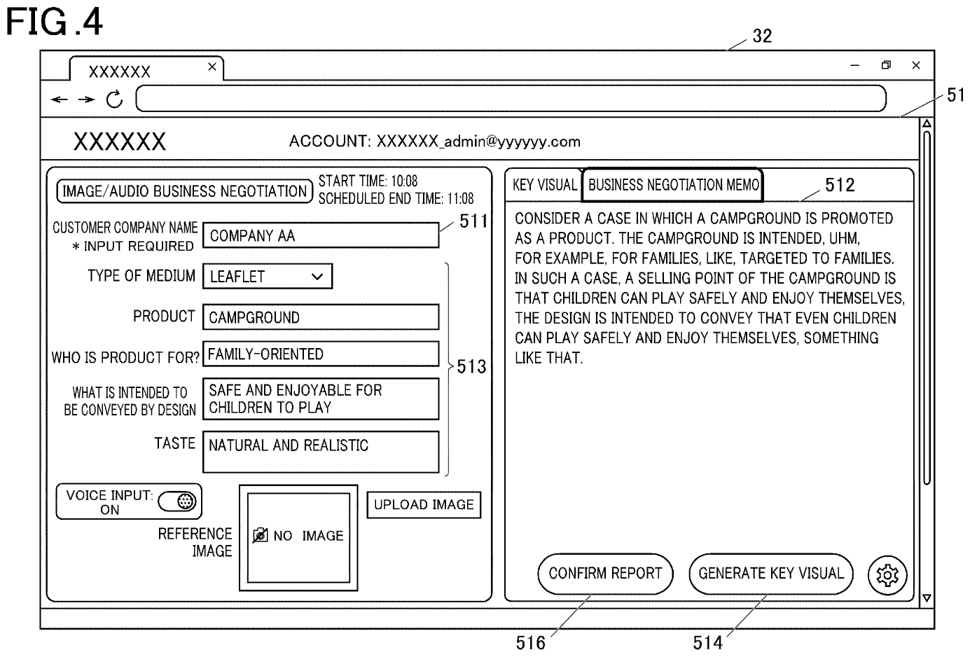

The acquisition section of the apparatus 10 acquires the audio data from the terminal 30 (step S102; audio acquisition step). When the acquisition section acquires audio data, the conversion section converts the audio data into the text data (step S103; conversion step). As shown in FIG. 4, the display controller displays the converted text data in a business negotiation memo display part 512 of the image generation screen 51. Further, the extraction section extracts requirements from the text data (step S104; extraction step). As shown in FIG. 4, the display controller displays, in a design requirements field 513, the design requirement among the requirements extracted by the extraction section.

If, for example, the content of the design requirements extracted by the extraction section does not match the content of the actual business negotiation such as when the voice volume of the user and/or the client is insufficient, the user may appropriately change the content displayed in the design requirements field 513 by operating the operation input section 33 of the terminal 30.

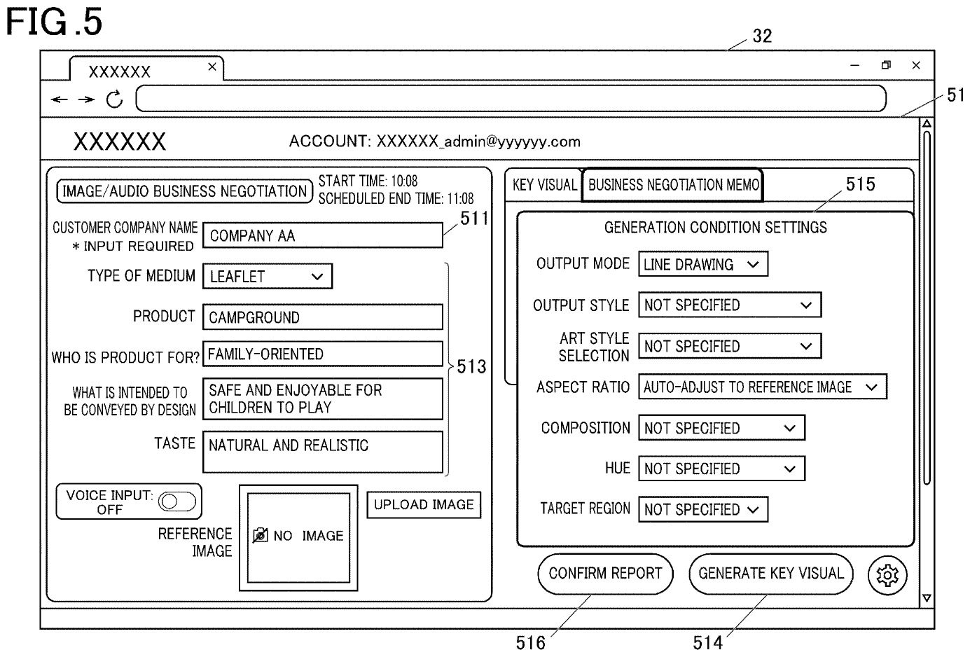

Upon receiving, from the user, the instruction to set the generation condition, the display controller of the apparatus 10 displays, on the display part 32 of the terminal 30, a generation condition setting screen 515 as shown in FIG. 5. At this time, the display controller displays, on the generation condition setting screen 515, only the generation option and keyword (art style name) that are to be displayed so as to be selectable by the user (step S105).

For example, based on the client setting, the display controller of the apparatus 10 refers to the record whose client name is “Company AA” in the option management table 1513. The display controller then displays, on the generation condition setting screen 515, only the generation option that is set to be displayable in the record so as to be selectable by the user.

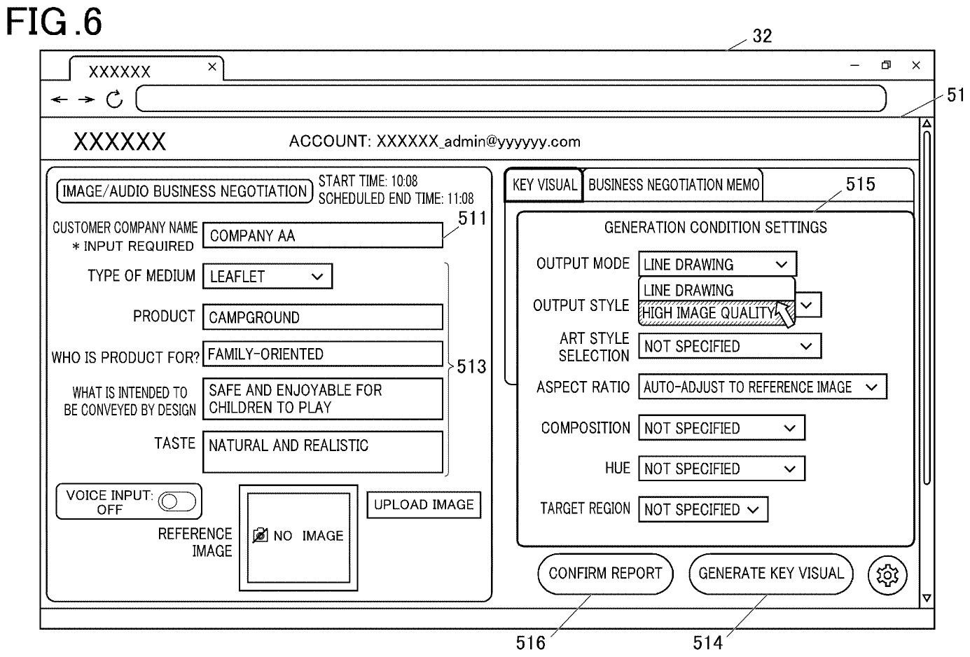

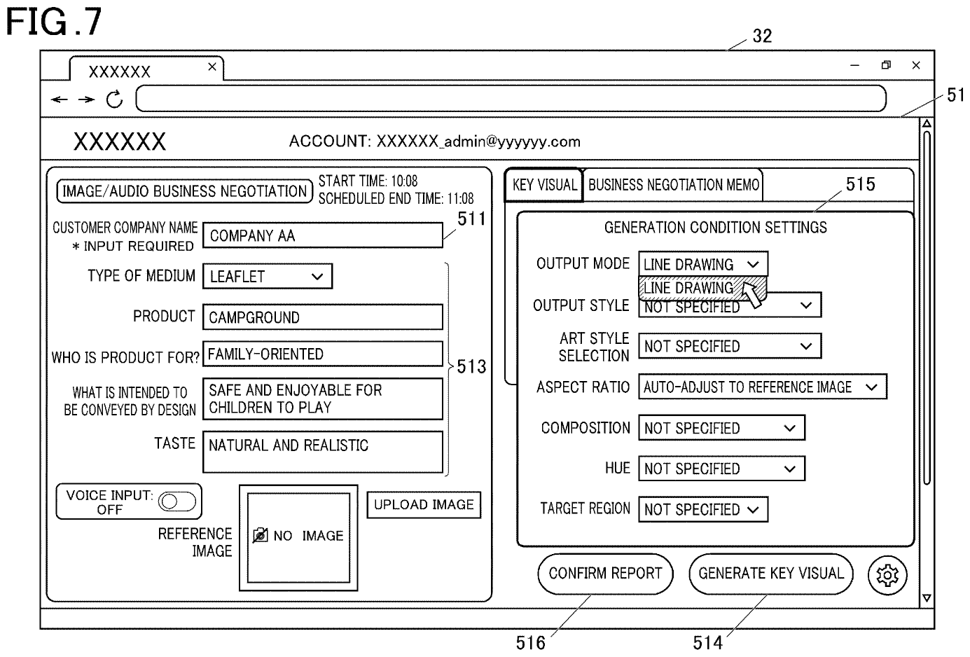

More specifically, it is assumed that, in the record of the option management table 1513 whose client name is “Company AA”, the generation option “High Quality” is set to be displayable. In this case, as shown in FIG. 6, “High Quality” is displayed in an output mode setting field in the generation condition setting screen 515 so as to be selectable. On the other hand, it is assumed that, in the record in the option management table 1513 whose client name is “Company AA”, “High Quality” is set to be not displayable. In this case, as shown in FIG. 7, “high quality” is not displayed and cannot be set in the output mode setting field of the generation condition setting screen 515.

Depending on the client, the client may request a reduction in design production costs because the generative AI automatically generates a high-quality design. Accordingly, by pre-setting, for such client, that the output mode for outputting the high-quality design is not displayed and that only the generation option for outputting a low-quality design (e.g., a line drawing or a rough design) is displayed, it is possible to suppress receipt of such requests for price reductions.

Further, the display controller of the apparatus 10 refers to, in the learning management table 1514, the record whose client name is “Company AA”, and displays, on the generation condition setting screen 515, only the corresponding art style data as selectable.

For example, when designs are separately created for a plurality of different clients, creating the design for Company BB using the art style data for Company AA is not preferable because there is a risk that the design may be unintentionally leaked. On the other hand, such risk can be avoided by allowing the art style data for the predetermined client to be set only for that predetermined client.

On the generation condition setting screen 515, the user inputs (selects) the generation conditions such as an output mode (generation option), an output style, art style data, an aspect ratio, a composition, a color shade, and a target region, and sets a reference image. At this time, based on the learning result of the learning section as described above, the display controller of the apparatus 10 may initially set, in each selection field of the generation condition setting screen 515, the generation condition corresponding to the client, thereby reducing the user's time and effort for selection.

The controller 11 determines whether the image generation button 514 on the image generation screen 51 has been operated and whether an image generation instruction has been received from the terminal 30 (step S106). If no image generation instruction has been received (step S106; No), the process proceeds to step S102 to continue the business negotiations. If the image generation instruction has been received (step S106; Yes), the acquisition section of the apparatus 10 acquires the generation condition for the generated image based on settings on the generation condition setting screen 515 (step S107). The image generation controller of the apparatus 10 transmits the design requirement, the reference image, and the generation condition to the server 20, thereby causing to generate the generated image (step S108; image generation step). Specifically, the controller 21 of the server 20 causes the text generation AI to generate the prompt based on the design requirement, the generation condition, and the reference image acquired from the apparatus 10, and causes the image generation AI to generate the generated image using the prompt.

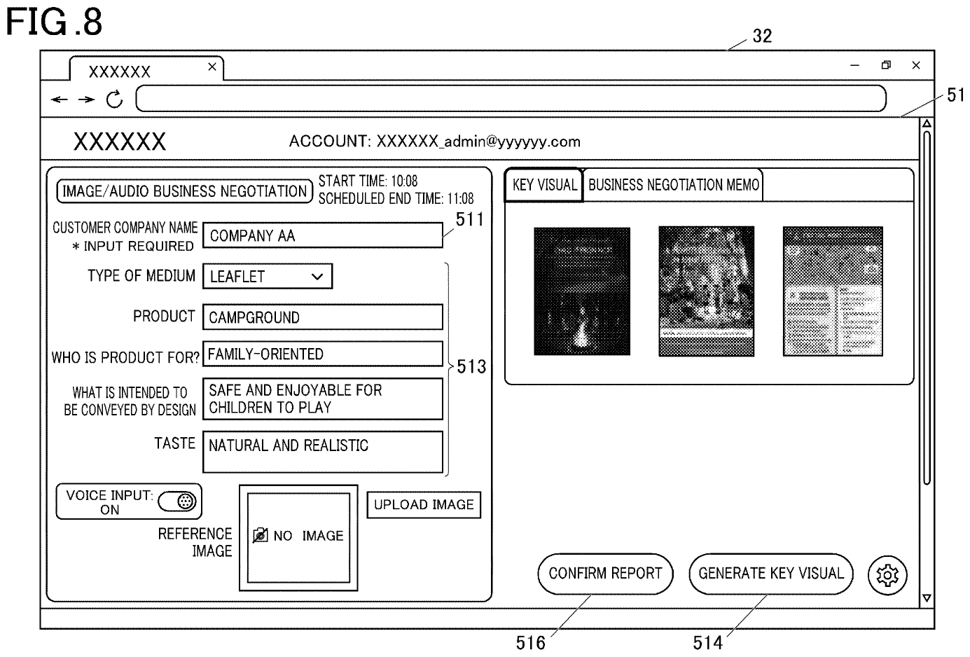

When the server 20 generates the generated image, the display controller of the apparatus 10 displays the generated image on the display part 32 of the terminal 30, as illustrated in FIG. 8 (step S109; display step). The user presents the generated image displayed on the display part 32 to the client and accepts feedback on the generated image from the client. The user inputs the received feedback as operation data via the operation input section 33 of the terminal 30. The feedback received from the client is not limited to a simple evaluation of whether the generated image is good or bad, and includes, for example, adjusting degrees of design elements on which the generated image is based, changing priorities of the design elements, and requesting addition of text or the image.

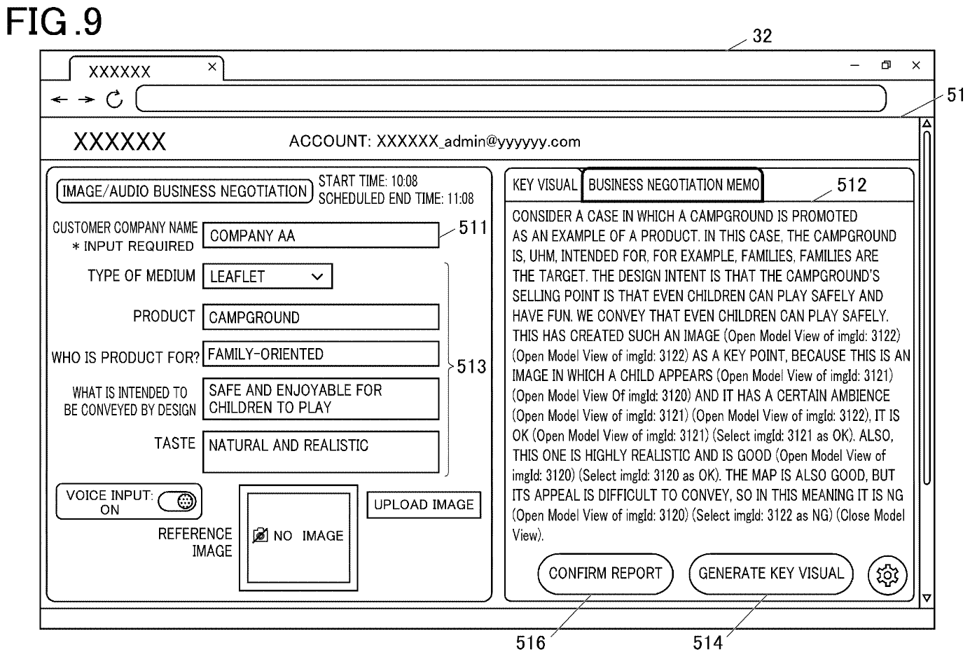

The acquisition section of the apparatus 10 acquires the operation data from the terminal 30 (step S110). Upon acquiring the operation data from the terminal 30, the conversion section converts the operation data into the text data in the same manner as the audio data (step S111). Further, as shown in FIG. 9, the display controller displays the converted text data in the business negotiation memo display part 512 of the image generation screen 51. As shown in FIG. 9, converting the audio data and the operation data into the text data in chronological order makes it possible to accurately reproduce the history of the business negotiation. The operation data to be converted into the text data by the conversion section is not limited to the operation data related to the feedback on the generated image.

The controller 11 determines whether the report generation button 516 on the image generation screen 51 has been operated and whether a report generation instruction has been received from the terminal 30 (step S112). When the business negotiation has not ended and the report generation instruction has not been received (step S112; No), the process proceeds to step S102 to continue the business negotiation. When the business negotiation has ended and the report generation instruction has been received (step S112; Yes), the report generation section generates the report 52 as shown in FIG. 10, based on the requirements extracted by the extraction section (step S113).

The report 52 is an output file that summarizes the content of the business negotiation by placing, in predetermined locations, the requirement extracted by the extraction section and the content of the text data obtained by converting the operation data. For example, in the report 52 illustrated in FIG. 10, “[Project Objective/Concept]” and “[Production/Specification Information]” are fields in which the design requirements are placed at respective preset positions. In addition, “[Image Selection Information]” is the field in which each generated image is placed at a position set for each evaluation, based on the text data representing the operation data of the feedback for each generated image. Further, “[Delivery Schedule]” is the field in which the meeting requirement is placed at respective preset positions.

When the content of the generated report 52 does not conform to the contents of the business negotiation, the user may, after correcting the output content in the business negotiation memo display part 512 by operating the operation input section 33 of the terminal 30, operate the report generation button 516 again to regenerate the report 52. Alternatively, the user may modify, as appropriate, the content to be output as the report 52 by operating the operation input section 33.

Upon completing the report 52, the user operates a report sending button 521. Upon receiving the operation of the report sending button 521, the transmitting section transmits the report 52 or the information related to the report 52 to the client (step S114).

For example, the transmitting section transmits the report 52 to the client in a predetermined file format (a PDF file, a spreadsheet, or the like). Alternatively, as information related to the report 52, the transmitting section transmits, to the client, the URL at which the report 52 can be displayed, or the URL of an uploader to which the report in a predetermined file format has been uploaded. Further, the controller 11 stores the data of the business negotiation in the project management table 1511 of the storage section 15.

### Effects of the Embodiment

As described above, the program according to the present embodiment causes the computer of the apparatus 10 to function as an acquisition section configured to acquire the audio data, the conversion section configured to recognize the audio data and convert the audio data into the text data, and the extraction section configured to extract the requirement from the text data. The program also causes the computer to function as the image generation controller configured to cause the image generation AI to generate the generated image on the basis of the design requirement included in the requirements, and as the display controller configured to display the generated image on the display part 32. According to the above-described configuration, the generated image can be generated on the basis of the audio data of the business negotiation, and the user and the client can share the idea by displaying the generated image on the display part 32. Accordingly, occurrences of discrepancies can be suppressed, thereby reducing man-hours and costs related to design production.

The conversion section converts the audio data into the text data by using the natural language processing or the LLM. According to the above configuration, highly accurate conversion can be performed in real time.

In addition, the conversion section recognizes the operation data of the user at a time of acquisition of the audio data and converts the audio data, together with the operation data, into the text data. According to the above-described configuration, reproducibility of the business negotiation based on the text data can be further improved.

In addition, the program causes the computer of the apparatus 10 to function as the report generation section that generates the report 52 based on the requirement. According to the above configuration, man-hours required for the user to reorganize the business negotiation content from the text data are reduced.

The operation data includes an input operation by the user for inputting the evaluation of the generated image, and the report generation section generates the report 52 including the evaluation. According to the configuration, the client's evaluation of the generated image that is generated is clarified, and the evaluation can be effectively used for the design production after the business negotiation.

Further, the report generation section generates the report 52 in which the generated images are classified for each evaluation. According to this configuration, the evaluation of each generated image becomes clearer.

In addition, the program causes the computer of the apparatus 10 to function as the transmitting section configured to transmit the report 52 or information related to the report 52 to the client. According to the above-described configuration, alignment of understanding and ideas with the client is further facilitated.

### Other Configurations

Although specific description has been given above based on embodiments according to the present disclosure, the present disclosure is not limited to the above-described embodiments. It should be understood that various modifications of the present disclosure can be made within the scope of the invention set forth in the appended claims and equivalents thereof.

For example, in the above description, a case has been described in which the apparatus 10 is a physical device and the server 20 is a cloud server, however, the present disclosure is not limited thereto, and the opposite configuration may be employed. Also, in the above description, a configuration in which the design project management system 100 includes three devices, namely, the apparatus 10, the server 20, and the terminal 30, has been described, however, the present disclosure is not limited thereto.

Further, in the above description, a case has been described in which the conversion section of the apparatus 10 converts the audio data acquired during the business negotiation into the text data in real time, however, the present disclosure is not limited thereto. For example, the conversion section may convert the audio data recorded during the business negotiation into the text data.

In the above description, an example has been disclosed in which a hard disk, a semiconductor nonvolatile memory, or the like is used as a computer-readable medium storing the program according to the present disclosure; however, the present disclosure is not limited to this example. As another computer-readable medium, a portable computer-readable recording medium such as a CD-ROM may be used. In addition, a carrier wave (carrier signal) is also applicable as a medium for providing data of the program according to the present disclosure via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A non-transitory computer-readable recording medium storing a program that causes a hardware processor included in a computer of a design project management apparatus to perform,
acquiring audio data,
recognizing the audio data and converting the audio data into text data,
extracting a requirement from the text data,
causing an image generation AI to generate a generated image based on a design requirement included in the requirement, and
displaying the generated image on a display.

2. The recording medium according to claim 1, wherein the hardware processor converts the audio data into the text data using natural language processing or an LLM.

3. The recording medium according to claim 1, wherein the hardware processor recognizes operation data of a user during acquisition of the audio data and converts the audio data and the operation data into the text data.

4. The recording medium according to claim 3, wherein the hardware processor generates a report based on the requirement.

5. The recording medium according to claim 4, wherein,
the operation data includes an input operation by the user regarding an evaluation of the generated image, and
the hardware processor generates the report that includes the evaluation.

6. The recording medium according to claim 5, wherein the hardware processor generates the report in which the generated image generated for each evaluation is classified.

7. The recording medium according to claim 4, wherein the hardware processor transmits the report or information regarding the report to a client.

8. A design project management apparatus comprising:
a hardware processor,
wherein the hardware processor is configured to perform,
acquiring audio data,
recognizing the audio data and converting the audio data into text data,
extracting a requirement from the text data,
causing an image generation AI to generate a generated image based on a design requirement included in the requirement, and
displaying the generated image on a display.

9. A design project management system comprising:
the design project management apparatus according to claim 8;
an image generating server configured to cause the image generation AI to generate the generated image; and
a user terminal including a sound collector configured to convert audio into the audio data, and the display configured to display the generated image.

10. A design project management method performed by a computer of a design project management apparatus, the method comprising:
acquiring audio data,
recognizing the audio data and converting the audio data into text data,
extracting a requirement from the text data,
causing an image generation AI to generate a generated image based on a design requirement included in the requirement, and
displaying the generated image on a display.
